(19) United States
(12) Patent Application Publication
(10) Pub. No.: US 2018/0251340 A1
(43) Pub. Date: Sep. 6, 2018

(54) ACCESSIBLE ELEVATOR BUFFER

(71) Applicants: Aurélien Fauconnet, GIEN (FR); Otis Elevator Company, Farmington, CT (US)

(72) Inventors: Aurelien Fauconnet, Isdes (FR); Frederic Beauchaud, Coullons (FR); Bi Xiong, Gien (FR)

(21) Appl. No.: 15/752,971

(22) PCT Filed: Sep. 25, 2015
(86) PCT No.: PCT/IB2015/001972

§ 371 Date: Feb. 15, 2018

(51) Int. Cl. B66B 5/28

(52) U.S. Cl. CPC B66B 5/288

(57) ABSTRACT

An accessible buffer assembly for a buffer of an elevator shaft is provided. The assembly includes a mounting frame configured in a pit of an elevator shaft and a buffer movably attached to the mounting frame and configured to provide a safety feature to the elevator car. A handle is operably connected to the buffer and configured to move the buffer. The buffer is movable from a first position to a second position, the first position being a secured, operational position of the buffer to provide the safety feature, and the second position being an inspection position wherein the buffer is removed from the first position.

BACKGROUND

The subject matter disclosed herein generally relates to buffers for elevators and, more particularly, to accessible buffers in an elevator pit.

Traditional safety requirements for elevator shafts have led to larger spaces both at the top and bottom of the elevator shaft. However, such enlarged spaces may be disadvantageous for architectural reason. Thus, elevator lift manufacturers have attempted to reduce hoistway or elevator shaft overhead dimensions and pit depth while maintaining safety features. The two dimensions (overhead dimension and pit depth, also referred to collectively as safety volumes) are key characteristics for elevator construction and design. Mechanics currently go to the top of car, or on top thereof, or in the pit, for inspection or maintenance activity of various components of an elevator car system. Thus, safety spaces or volumes are employed within the elevator shaft to protect a mechanic in the event of an emergency and thus require increased overhead and pit dimensions. The safety volumes of an elevator shaft may impact the dimensions and construction of a building that houses the elevator.

The required dimensions of the safety volumes on the top of the car and in the pit may be increased to provide safety to technicians located in either safety volume during maintenance, inspection, etc. Accordingly, the hoistway dimensions may be increased, which may not be desirable for overall building construction and design.

The dimensions in the pit may be provided for access to the underside of an elevator car to enable inspection and maintenance by a technician of various components installed thereon and/or components located within the pit. Buffers are devices configured to soften the force with which an elevator runs into a pit of an elevator shaft during an emergency. Buffers are safety devices/components that are configured in terms of an ability to decelerate or stop an elevator car in the event of an emergency and thus may require regular inspection and/or maintenance to maintain proper operation. Buffers may be located on the bottom of an elevator car or located within the pit of the elevator hoistway. The buffers installed in the hoistway may be spring buffers and/or hydraulic/oil buffers, or other types of buffers, which are installed in the pit of an elevator shaft. These buffers are fixed to the floor or surface of the pit and are configured to impact a bottom surface of an elevator car. Buffers installed on an elevator car are configured to reduce or minimize impacts during an emergency by impacting the floor or a surface of the pit of the elevator shaft. The buffers may require inspection and maintenance from time to time to ensure proper operation and ability to properly provide the safety mechanism.

### SUMMARY

According to one embodiment, an accessible buffer assembly for a buffer of an elevator shaft is provided. The assembly includes a mounting frame configured in a pit of an elevator shaft and a buffer movably attached to the mounting frame and configured to provide a safety feature to the elevator car. A handle is operably connected to the buffer and configured to move the buffer. The buffer is movable from a first position to a second position, the first position being a secured, operational position of the buffer to provide the safety feature, and the second position being an inspection position wherein the buffer is removed from the first position.

In addition to one or more of the features described above, or as an alternative, further embodiments of the assembly may include a connector operably connecting the handle to the buffer, the connector supported by the mounting frame.

In addition to one or more of the features described above, or as an alternative, further embodiments of the assembly may include a securing mechanism configured to secure the buffer in the first position.

In addition to one or more of the features described above, or as an alternative, further embodiments of the assembly may include a safety switch configured to prevent operation of an elevator car when the buffer is not secured in the first position.

In addition to one or more of the features described above, or as an alternative, further embodiments of the assembly may include a support fixed to a floor of the pit and configured to separate the buffer from the floor of the pit.

In addition to one or more of the features described above, or as an alternative, further embodiments of the assembly may include that the buffer includes a pin, wherein the pin is configured to secure the buffer to the support in the first position.

In addition to one or more of the features described above, or as an alternative, further embodiments of the assembly may include that the mounting frame is fixedly secured to a guide rail of the elevator shaft.

In addition to one or more of the features described above, or as an alternative, further embodiments of the assembly may include that the buffer is one of a foam buffer and a hydraulic buffer.

In addition to one or more of the features described above, or as an alternative, further embodiments of the assembly may include an elevator car, the elevator car having an access panel configured to enable a user to access and operate the handle from within the elevator car.

According to another embodiment, a method of operating a buffer assembly of an elevator system is provided. The method includes accessing a buffer assembly located in a pit of an elevator shaft from an interior of the elevator car, disengaging the buffer from a first position wherein the buffer is secured in an operational position, moving the buffer to a second position wherein the buffer is removed from the first position, moving the buffer back to the first position, and re-engaging the buffer in the first position.

In addition to one or more of the features described above, or as an alternative, further embodiments of the method may include that disengaging the buffer comprises disengaging a securing mechanism of the buffer assembly.

In addition to one or more of the features described above, or as an alternative, further embodiments of the method may include that the moving of the buffer from the first position to the second position and from the second position to the first position comprises pulling the buffer upward from below the elevator car.

In addition to one or more of the features described above, or as an alternative, further embodiments of the method may include opening an access panel of an elevator car prior to accessing the buffer assembly and closing the access panel after re-engaging the buffer in the first position.

In addition to one or more of the features described above, or as an alternative, further embodiments of the method may include performing at least one of an inspection operation and a maintenance operation on the buffer when the buffer is in the second position.

addition to one or more of the features described above, or as an alternative, further embodiments of the method may include disengaging a safety switch to prevent operation of the elevator car when the buffer is not secured in the first position

Technical effects of embodiments of the present disclosure include access to a buffer located in an elevator pit for maintenance and repair from inside an elevator car. Further technical effects include a movable buffer that may be fixed in place in a first position and moved therefrom to a second position.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the disclosure;

FIG. 2A is a schematic view of an accessible buffer system in accordance with an embodiment;

FIG. 2B is a schematic view of the accessible buffer system of FIG. 2A, in a first position;

FIG. 2C is an alternative schematic view of the accessible buffer system of FIG. 2A, in the first position;

FIG. 2D is a schematic view of the accessible buffer system of FIG. 2A showing movement of a movable buffer;

FIG. 2E is an alternative schematic view of the accessible buffer system of FIG. 2A showing the movement of the moveable buffer;

FIG. 2F is a schematic view of the accessible buffer system of FIG. 2A, in a second position;

FIG. 2G is an alternative schematic view of the accessible buffer system of FIG. 2A, in the second position;

FIG. 3 is a process for operating an accessible buffer in accordance with an exemplary embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

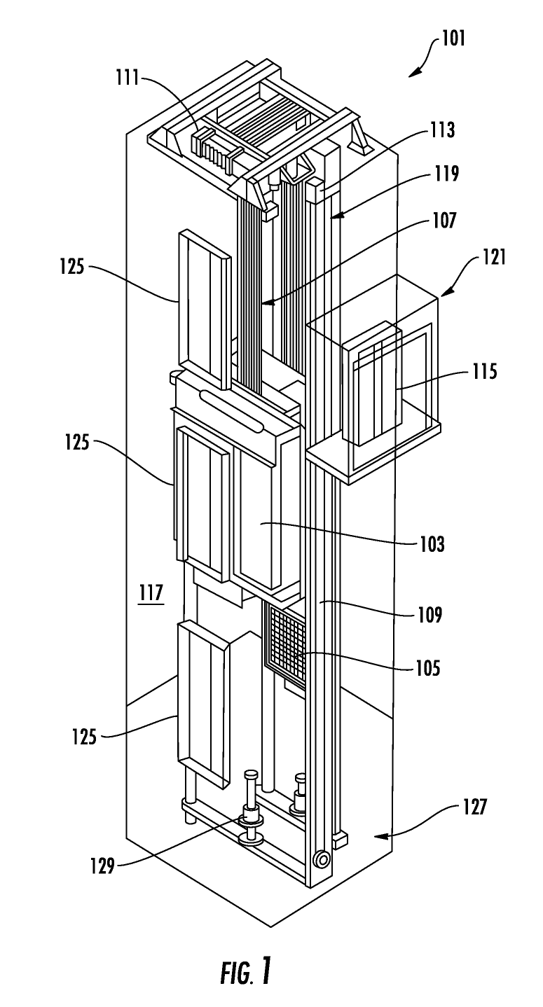

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

At the bottom of the elevator shaft 117, i.e., in pit 127, may be one or more buffers 129. The buffers 129 may be secured in the pit 127 of the elevator shaft 117 to the guide rail 109 whether on the vertical portion or the horizontal portion, as shown in FIG. 1. The buffers 129 may be hydraulic or foam type buffers, as known in the art, or may take other configurations. The buffers 129 are configured to impact a bottom surface of the elevator car 103 in the event the elevator car 103 falls within the elevator shaft 117. In alternative non-limiting embodiments, the buffers may be configured or fastened directly on or to a floor of the pit 127.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

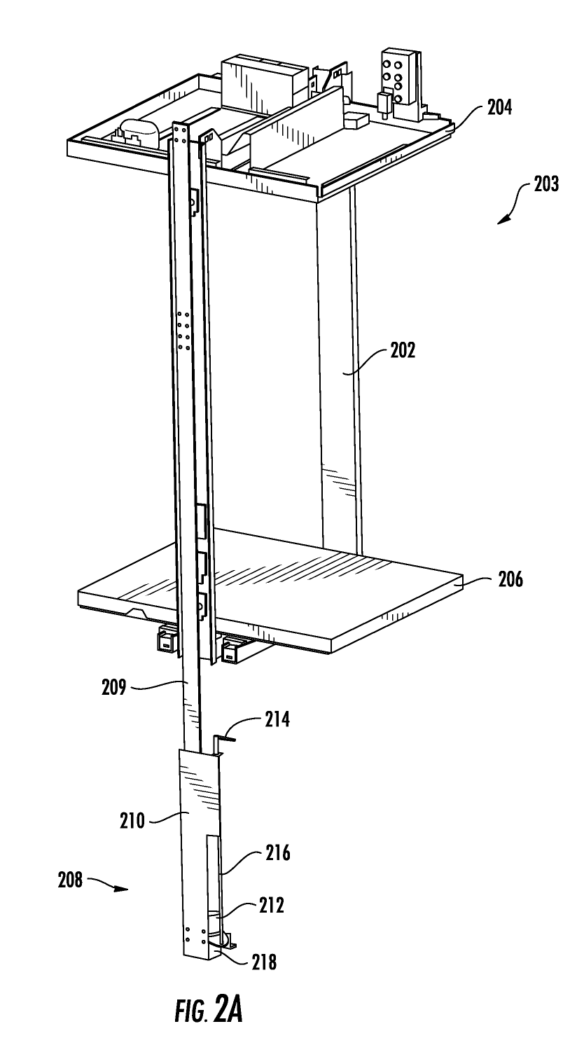

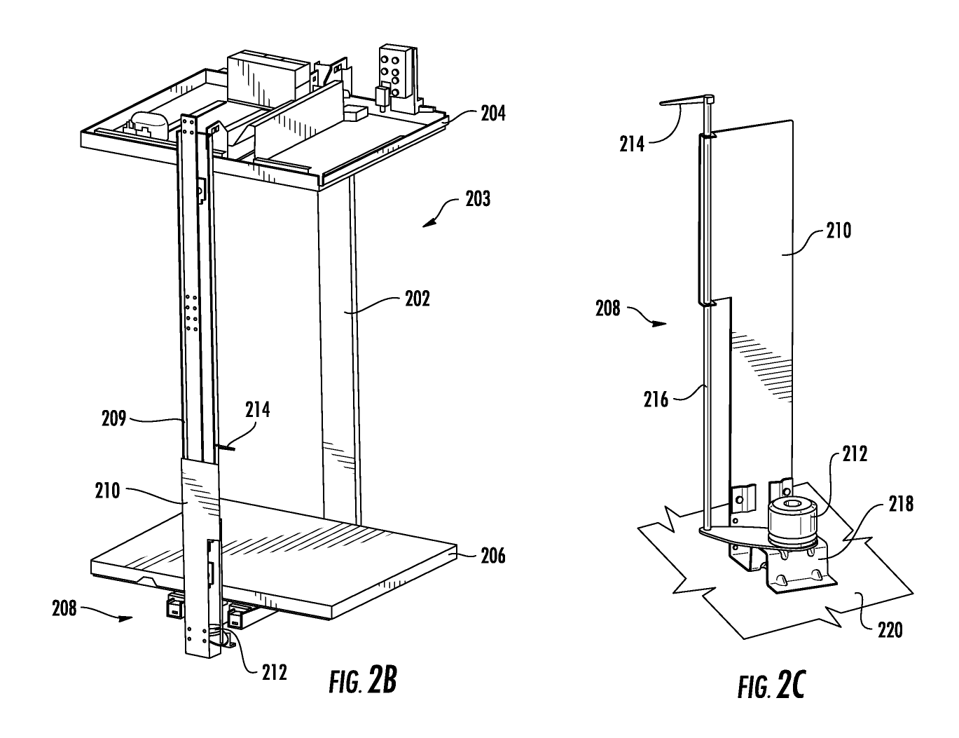

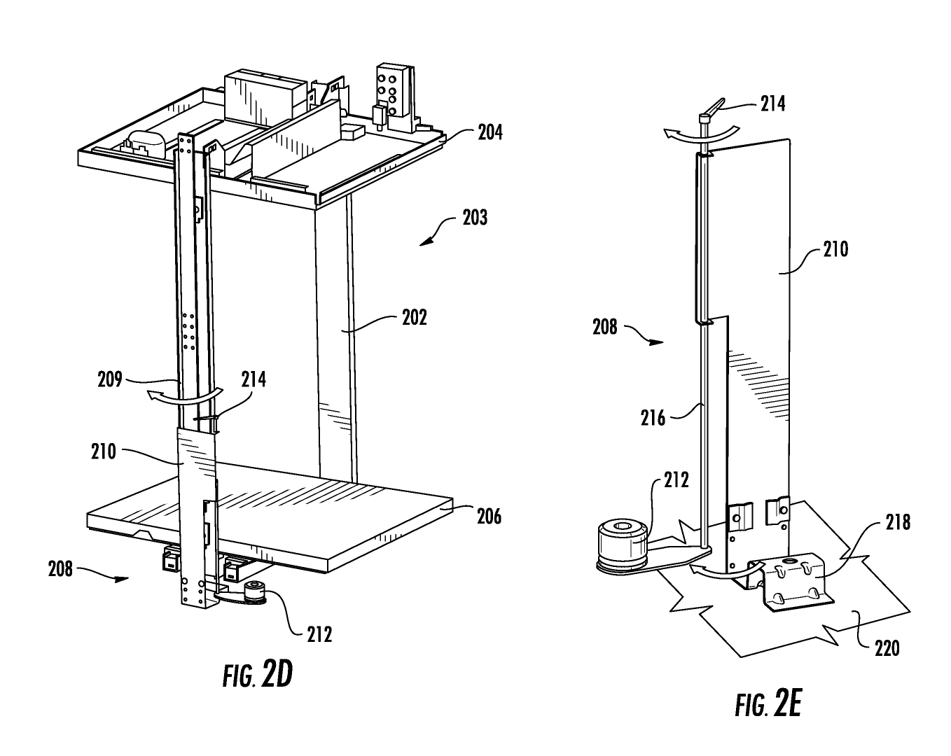

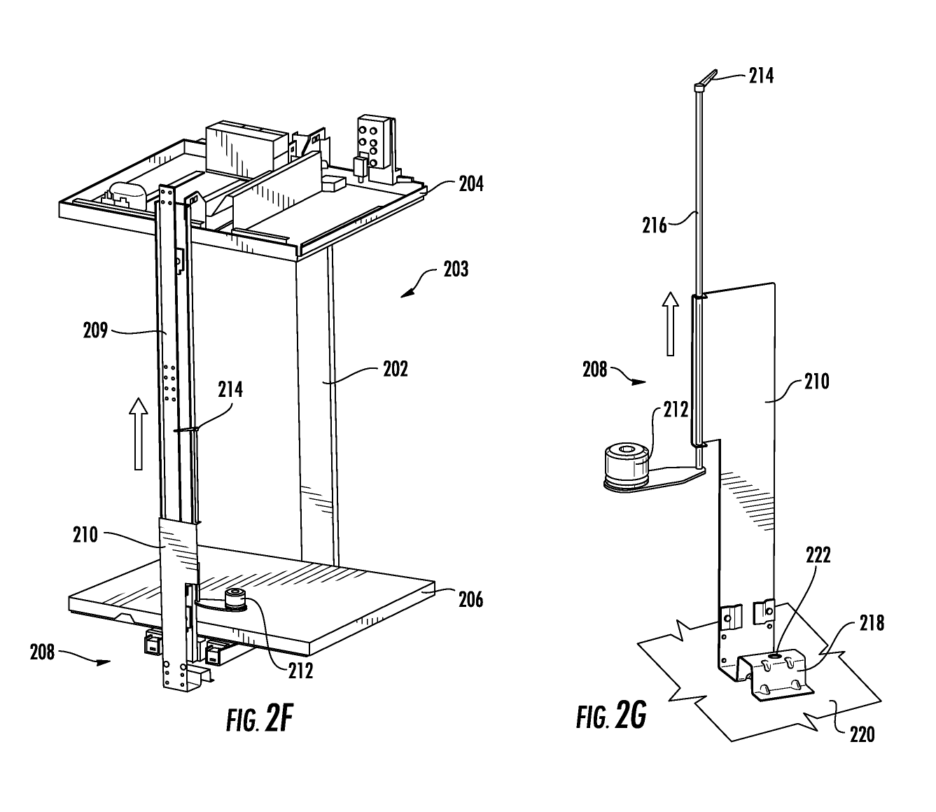

Turning now to FIGS. 2A-2G, various schematic views of an accessible buffer in accordance with a non-limiting embodiment are shown. As described herein, the operation of an example buffer will be provided. Further, as shown, various features or parts of an elevator car are not shown for simplicity. As such, in FIGS. 2A-2G, an elevator car 203 is shown with no walls/wall panels, and is shown having only an elevator car frame 202, an upper panel 204, and a lower panel 206. The frame 202 may include components and parts that enable the elevator car 203 to move along a guide rail 209. As shown in FIG. 2A, the elevator car 203 is located close to the bottom of the elevator shaft, i.e., close to the pit of the elevator shaft; FIGS. 2B, 2D, and 2F show the elevator car 203 at the lowest point relative to the guide rail 209.

In FIGS. 2A-2G, in the pit of the elevator shaft is an accessible buffer system 208. The accessible buffer system 208 includes a mounting frame 210, a buffer 212 removably attachable to the mounting frame 210, and a handle 214 that is configured to enable a user, such a technician or mechanic, to move the buffer 212 between a first position and a second position, as described herein. The mounting frame 210 may be attached to the guide rail 209 or may be separate therefrom. The mounting frame 210 is configured to support the buffer 212 and the handle 214 and enable operation thereof. The handle 214 may operably connect to the buffer 212 by a connector 216, with the connector movably connected to the mounting frame 210. The connector 216 may be a rod, chain, pole, or other type of connector. The buffer 212 may engage with and be supported on a support 218. The support 218 may be a bracket or other type of support and may be integral with and part of the mounting frame 210, and may be attached to and/or mounted on a pit floor 220 (as shown, e.g., in FIG. 2C). The support 218 may be configured to provide a clearance or space between the buffer 212 and the pit floor 220.

As shown in FIG. 2B, the elevator car 203 may be positioned at the lowest point within an elevator shaft that is possible during an operation mode and/or a maintenance mode of operation of the elevator car. That is, the lower panel 206 of the elevator car 203 is positioned near the buffer 212 within the pit of the elevator shaft. FIG. 2C shows an alternative schematic view of the configuration in FIG. 2B, but without the elevator car 203 shown for clarity. As shown in FIGS. 2A, 2B, and 2C, the accessible buffer system 208 is shown in a first position. In the first position, the buffer 212 is positioned within a pit of an elevator shaft such that it can absorb impact energy from an elevator car that may impact the buffer 212. That is, the first position may be an operational position or normal position.

With the elevator car 203 positioned as shown in FIG. 2B, a user, such as a technician or mechanic, may be able to open an access panel in a wall of the elevator car 203 (not shown). The access panel may grant the user access to the handle 214 and enable operation of the accessible buffer system 208.

Turning now to FIGS. 2D and 2E, an example movement of the accessible buffer system 208 is shown. A user may rotate the handle 214, as indicated by the arrows in FIGS. 2D and 2E. As the handle 214 is rotated, the connector 216 rotates as well. Thus, the buffer 212 will move away from the support 218 and into an intermediate position.

Then, as shown in FIGS. 2F and 2G, the buffer 212 may be raised upward, as indicated by the arrows, and positioned in a second position. The second position may be an inspection or maintenance position. With the buffer 212 positioned as shown, the user may be able to access the buffer 212 from within the elevator car 203 through the access panel. This enables inspection and/or maintenance to be performed on the buffer 212 without the user entering the pit of the elevator shaft.

The reverse process of that described above may be performed to return the buffer 212 to the first position.

As shown in FIG. 2G, the support 218 may include a securing mechanism 222. In some non-limiting embodiments, the securing mechanism 222 may be configured as a port or hole in the support 218 that enables a pin on the buffer 212 (not shown) to engage therewith and secure the buffer 212 in the first position. Other types of mechanical securing mechanisms may also be used. In another non-limiting embodiment, or in combination with the securing mechanism 222, the support 218 or another component may include a safety switch, e.g., as part of a safety chain of the elevator system. The safety switch may be part of an electrical contact or connection system that forms a complete circuit only when the buffer 212 is secured in the first position. When the buffer 212 is removed from the first position, the circuit of the safety switch may not be completed. If the circuit of the safety switch is not complete, then the elevator system may not be able to be moved or operated. Thus, the safety switch feature of the securing mechanism 222 may provide additional safety features. In another non-limiting embodiment, or in combination, the securing mechanism may include an indicator, such as a light, a sound, or other type of indicator, to indicate if the buffer 212 is positioned in the first position or not.

In some embodiments, the handle 214 may be configured to operate the securing mechanism 222. For example, in some embodiments, the handle 214 may include a switch or other type of trigger device that is operably connected to the securing mechanism 222. In one non-limiting example, the handle 214 may include a level that is manually operable to operate a pin or other locking device of the securing mechanism 222 such that the buffer 212 may be moved out of the first position.

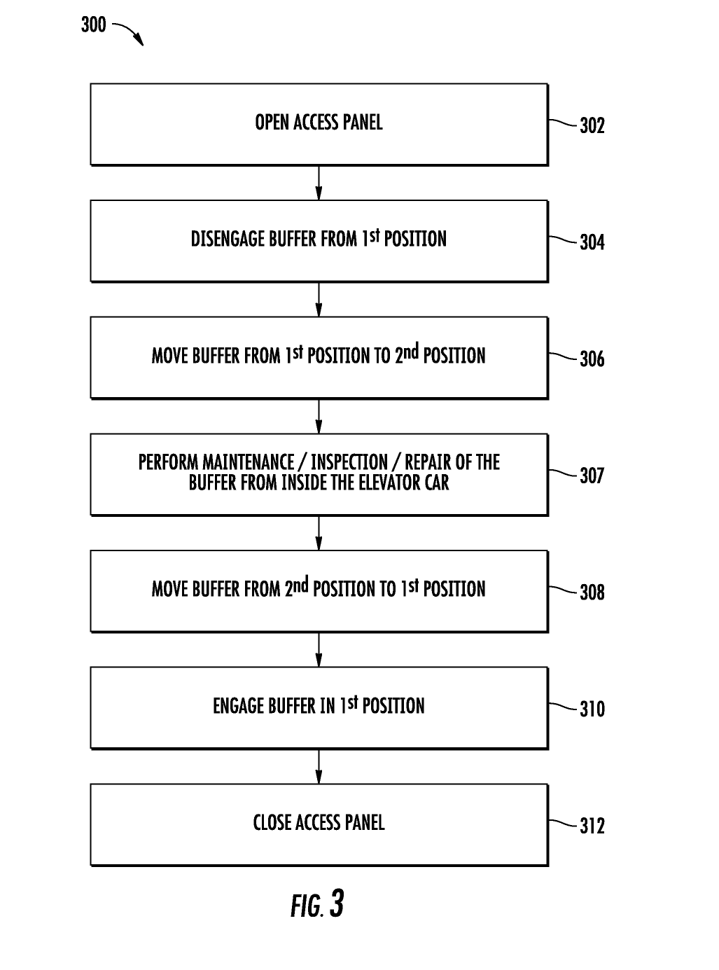

Turning now to FIG. 3, a flow process 300 for operating a buffer assembly in accordance with a non-limiting embodiment of the present disclosure is shown. The process 300 enables a user to inspect or perform maintenance on a buffer of an elevator car from inside the elevator car. Thus, in accordance with process 300, a user does not need to enter the pit of an elevator shaft and be subject to risks associated therewith. The process may be employed with a configuration as shown and described above. Further, the process may be used to inspect and perform maintenance on buffers that are configured within the pit of the elevator shaft from within the elevator car.

At step 302 a user may open an access panel of the elevator car. The access panel may be an entire side wall of the elevator car or may be a portion thereof. With the access panel removed or opened, the user may then disengage a buffer from a first position at step 304. For example, step 304 may include unlocking the buffer from the first position, such as by disengaging a lock-pin or employing some other release mechanism that may be operable using a handle of the buffer system. In other embodiments, the unlocking mechanism may be a spring-biased locking pin or other similar device. Further, in other embodiments, the unlocking mechanism may be electronic and/or magnetic. Step 304 may also include disengaging the buffer from a safety mechanism, including, for example, a safety chain, thus adding additional security to ensure the elevator is not operated when inspection/maintenance of the buffer is occurring.

After disengaging the buffer from the first position at step 304, the user may then move the buffer at step 306 to a second position. The second position may be a position that enables inspection, maintenance, and/or repair to be performed on the buffer from inside the elevator car at step 307. In one example, the user may rotate a handle, and thus rotate the buffer, and then pull or slide the buffer upward from below the elevator car to be level with the opening in the elevator car.

Subsequently, the user may then move the buffer from the second position back to the first position at step 308. The user may then engage, secure, and/or lock the buffer in the first position at step 310, such that the buffer is securely fixed in the pit of the elevator shaft and is capable of performing the safety function of a buffer during operation of the elevator car. Finally, the user may replace or close the access panel at step 312.

Advantageously, embodiments described herein provide an accessible buffer for an elevator system that enables a user to access the buffer from within the elevator car. Further, advantageously, the amount of space required in the pit of an elevator shaft may be reduced by embodiments described herein, thus enabling the elevator system to take up less space in a building.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although shown and described with respect to a foam-type buffer, those of skill in the art will appreciate that other types of buffers may benefit from embodiments described herein. For example a hydraulic buffer may be configured to operate similarly as described above such that inspection and/or maintenance of a hydraulic buffer may be performed from within the elevator car. Further, although shown and described with a specific movement mechanism, i.e., the handle and connector, those of skill in the art will appreciate that various different connectors and/or handles and movement mechanisms may be employed without departing from the scope of the present disclosure. Moreover, for example, although shown and described as having a rotational movement, those of skill in the art will appreciate that the buffer system may be arranged such that the buffer is moved by translation, rotation, sliding, or other type of movement, without departing from the scope of the present disclosure.

Accordingly, the present disclosure is not to be seen as limited by the foregoing description, but is only limited by the scope of the appended claims.

1. An accessible buffer assembly for a buffer of an elevator shaft, the assembly comprising:
a mounting frame configured in a pit of an elevator shaft;
a buffer movably attached to the mounting frame and configured to provide a safety feature to the elevator car; and
a handle operably connected to the buffer and configured to move the buffer, wherein the buffer is movable from a first position to a second position, the first position being a secured, operational position of the buffer to provide the safety feature, and the second position being an inspection position wherein the buffer is removed from the first position.

2. The buffer assembly of claim 1, further comprising a connector operably connecting the handle to the buffer, the connector supported by the mounting frame.

3. The buffer assembly of claim 1, further comprising a securing mechanism configured to secure the buffer in the first position.

4. The buffer assembly of claim 1, further comprising a safety switch configured to prevent operation of an elevator car when the buffer is not secured in the first position.

5. The buffer assembly of claim 1, further comprising a support fixed to a floor of the pit and configured to separate the buffer from the floor of the pit.

6. The buffer assembly of claim 5, wherein the buffer includes a pin, wherein the pin is configured to secure the buffer to the support in the first position.

7. The buffer assembly of claim 1, wherein the mounting frame is fixedly secured to a guide rail of the elevator shaft.

8. The buffer assembly of claim 1, wherein buffer is one of a foam buffer and a hydraulic buffer.

9. The buffer assembly of claim 1, further comprising an elevator car, the elevator car having an access panel configured to enable a user to access and operate the handle from within the elevator car.

10. A method of operating a buffer assembly of an elevator system, the method comprising:
accessing a buffer assembly located in a pit of an elevator shaft from an interior of the elevator car;
disengaging the buffer from a first position wherein the buffer is secured in an operational position;
moving the buffer to a second position wherein the buffer is removed from the first position;
moving the buffer back to the first position; and
re-engaging the buffer in the first position.

11. The method of claim 10, wherein disengaging the buffer comprises disengaging a securing mechanism of the buffer assembly.

12. The method of claim 10, wherein the moving of the buffer from the first position to the second position and from the second position to the first position comprises pulling the buffer upward from below the elevator car.

13. The method of claim 10, further comprising:
opening an access panel of an elevator car prior to accessing the buffer assembly; and
closing the access panel after re-engaging the buffer in the first position.

14. The method of claim 10, further comprising performing at least one of an inspection operation and a maintenance operation on the buffer when the buffer is in the second position.

15. The method of claim 10, further comprising disengaging a safety switch to prevent operation of the elevator car when the buffer is not secured in the first position.
